(19) United States
(12) Patent Application Publication
(10) Pub. No.: US 2012/0042054 A1
(43) Pub. Date: Feb. 16, 2012

(54) System and Method for Virtual Switch Architecture to Enable Heterogeneous Network Interface Cards within a Server Domain

(75) Inventors: Saikrishna Kotha, Austin, TX (US); Gaurav Chawla, Austin, TX (US)

(73) Assignee: DELL PRODUCTS, LP, Round Rock, TX (US)

(21) Appl. No.: 12/856,247

(22) Filed: Aug. 13, 2010

(51) Int. Cl. G06F 9/455; G06F 15/177

(52) U.S. Cl. 709/220; 718/1

(57) ABSTRACT

A server includes a plurality of virtual machines partitioned on the server and a first virtual switch. The first virtual switch is in communication with the virtual machines, and is configured to detect a connection of a first converged network adapter to the server, to determine network requirements of the virtual machines, and to determine whether the first converged network adapter has a first virtual network interface card that is compatible with the network requirements of the virtual machines. If the first virtual network interface card of the first converged network adapter is compatible with the network requirements of the virtual machines, then the first virtual switch provisions the first virtual network interface card as a second virtual switch for the virtual machines, otherwise the first virtual switch provisions a software-based virtual network interface card in the first virtual switch.

### FIELD OF THE DISCLOSURE

This disclosure relates generally to information handling systems, and more particularly relates to a system and a method for virtual switch architecture to enable heterogeneous network interface cards within a server domain.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In a server domain, a software based virtual switch (vSwitch) can provide the functionality to create, configure and manage virtual network interface card (vNIC) ports within the vSwitch. The vNICs in the vSwitch can provide data routing to and from virtual machines partitioned on the server domain based on data traffic policies set for virtual machines. The data traffic policies for the virtual machines can be set in a network architecture of the server domain. The data routing of the vNICs in the vSwitch can also be offloaded to vNICs of converged network adapters connected to the server. Thus, vNICs within the vSwitch or vNICs within a converged network adapter can control the data routing for the virtual machines.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of an information handling system including virtual machines and converged network adapters;

FIG. 2 is a block diagram of an embodiment of a system architecture of a virtual switch in the information handling system;

FIG. 3 is a block diagram of another embodiment of a system architecture of the information handling system;

FIG. 4 shows a flow diagram of method for configuring a converged network adapter connected to the information handling system;

FIG. 5 is a flow diagram of another method for configuring a converged network adapter connected to the information handling system; and

FIG. 6 is a block diagram of a general computer system.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other teachings can certainly be utilized in this application.

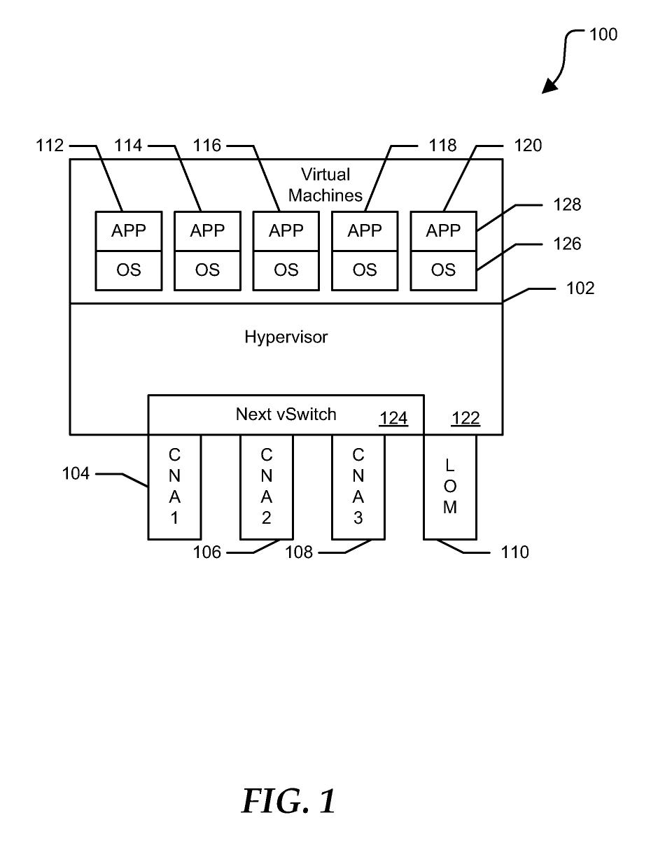

FIG. 1 shows an information handling system 100. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The information handling system 100 includes a server 102, converged network adapters (CNAs) 104, 106, and 108, and a local area network (LAN) on motherboard (LoM) card 110. The server 102 can be placed in physical communication with the CNAs 104, 106, and 108, and with the LoM card 110 by plugging the CNAs and the LoM into physical ports on the server. The server 102 can include virtual machines 112, 114, 116, 118, and 120, a hypervisor 122, and a virtual switch (vSwitch) 124. The hypervisor 122 and the virtual switch 124 can be in communication with the virtual machines 112, 114, 116, 118, and 120, with the CNAs 104, 106, 108, and with the LoM card 110.

The hypervisor 122 can also include software and/or firmware generally operable to allow multiple operating systems to run on the information handling system 100 at the same time. This operability can be generally allowed via virtualization, a technique for hiding the physical characteristics of the server 102 resources from the way in which other systems, applications, or end users interact with those resources. In one embodiment, the hypervisor 122 can include a specially designed operating system with native virtualization capabilities. In another embodiment, the hypervisor 122 can include a standard operating system with an incorporated virtualization component for performing virtualization.

To allow multiple operating systems to run on the information handling system 100 at the same time, the hypervisor 122 can virtualize the hardware resources of the server 102 and present virtualized computer hardware representations to each of the virtual machines 112, 114, 116, 118, and 120. Each of the virtual machines 112, 114, 116, 118, and 120 can include an operating system 126, along with any applications 128 or other software running on the operating system. Each operating system 126 on the virtual machines 112, 114, 116, 118, and 120 can be any operating system compatible with and/or supported by the hypervisor 122. During operation, the hypervisor 122 of the information handling system 100 can virtualize the hardware resources of the server 102 and present virtualized computer hardware representations to each of the virtual machines 112, 114, 116, 118, and 120. Each operating system 126 of the virtual machines 112, 114, 116, 118, and 120 can then begin to operate and run the applications 128 and/or other software. While operating, each operating system 126 can utilize one or more hardware resources of the server 102 assigned to the respective virtual machine by the hypervisor 122.

The vSwitch 124 can interact with the operating systems 126 and the applications 128 of the virtual machines 112, 114, 116, 118, and 120 to control data transfers to and from the virtual machines. The vSwitch 124 of the hypervisor 122 can also detect when a new CNA or a new LoM, such as the CNA 108 or the LoM 110, is connected to the sever 102. The CNAs 104, 106, and 108, and the LoM 110 can be utilized to control data transfers to and from the virtual machines. When the CNA 108 is connected, the vSwitch 124 can send a register request to the CNA via an application programming interface (API). The API can be an interface implemented by the vSwitch 124, which enables the vSwitch to interact with a software driver of the CNAs 104, 106, and 108. The driver of CNA 108 can reply to the register request to register the CNA during an initialization period of the CNA. When the CNA 108 has registered with the vSwitch 124, the vSwitch can send a discover attributes request to the CNA, and the CNA driver can provide the vSwitch 124 with the capabilities and configuration of the CNA. The capabilities of the CNA 108 can include capabilities of a virtual switch, a virtual network interface controller (vNIC), and the like on the CNA.

The vSwitch 124 can configure the CNA 108 based on the capabilities and configuration received from the CNA driver and data traffic policies set for the virtual machines 112, 114, 116, 118, and 120. The vSwitch 124 can transmit a configure attributes request to the CNA 108 to provide the CNA with an operation code for the operation and a data structure containing the configuration information. For example, if the CNA 108 has the capability of implementing a virtual switch or a vNIC within the CNA, the vSwitch 124 can transmit the configure attributes request to cause the CNA to implement the virtual switch or the vNIC to provide data routing to or from the virtual machines 112, 114, 116, 118, and 120. However, if the capabilities of the CNA 108 returned to the vSwitch 124 indicate that the CNA 108 cannot implement a virtual switch or a vNIC or that the vNIC does not meet specific requirements set for the virtual machines 112, 114, 116, 118, and 120, then the vSwitch can create a software based vNIC based on software capabilities of the vSwitch. The vSwitch 124 can then perform the same operations stated above for additional CNAs connected to the server 102. Each CNA can be configured differently based on the capabilities and configurations of the individual CNA.

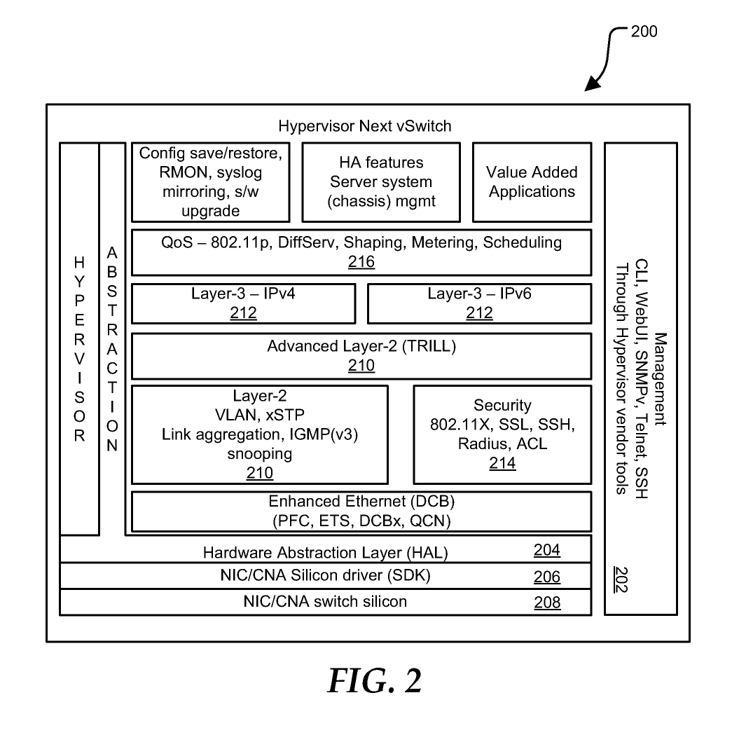

FIG. 2 shows a system architecture 200 of the information handling system 100. The system architecture 200 includes a management block 202, a hardware abstract layer (HAL) 204, a NIC/CNA silicon driver software development kit (SDK) 206, a NIC/CNA switch silicon layer 208, and different network architecture settings, such as layer-2 protocol features 210, layer-3 protocol features 212, security features 214, quality of service (QoS) requirements 216, and the like. The management block 202 can be utilized by a user to set up the different network architecture settings of the system architecture 200 for the virtual machines 112, 114, 116, 118, and 120, the hypervisor 122, and the vSwitch 124, shown in FIG. 1. For example, the management block 202 can set up the layer-2 protocol features 210, the layer-3 protocol features 212, the security features 214, and the QoS requirements 216 for the virtual machines 112, 114, 116, 118, and 120.

The vSwitch 124 can utilize the HAL 204 and the NIC/CNA SDK 206 to communicate with the NIC/CNA switch silicon 208 of the CNAs 104, 106, and 108. The CNAs 104, 106, and 108 can be made by different manufacturers, such that the NIC/CNA switch silicon 208 for each of the CNAs can be different. However, the HAL 204 can be an abstraction layer between the hardware of the CNAs 104, 106, and 108 and the software of the vSwitch 124. Thus, the HAL 204 can be implemented in the software of the vSwitch 124, and can hide the differences in hardware between the CNAs 104, 106, and 108 from the operating system of the vSwitch and the virtual machines 112, 114, 116, 118, and 120. Therefore, the HAL 204 can enable the vSwitch 124 and the virtual machines 112, 114, 116, 118, and 120 to communicate with the CNAs 104, 106, 108 without having to change operation codes for each CNA.

The NIC/CNA SDK 206 can be utilized in the vSwitch 124 for configuring the CNAs 104, 106, and 108. For example, the NIC/CNA SDK 206 can be an API used by the vSwitch 124 to send different requests and commands to configure the CNAs 104, 106, and 108 based on the system architecture 200 set up by a user via the management block 202. Thus, a user of the information handling system 100 can utilize the management block 202 to set up the system architecture 200 of the server 102, the virtual machines 112, 114, 116, 118, and 120, the hypervisor 122, and the vSwitch 124. Each of the CNAs 104, 106, and 108, and the vSwitch 124 can be configured during initialization of the information handling system 100, such that the settings of the system architecture 200 can be implemented on an individual CNA basis in either the CNA 104, 106, or 108, or the vSwitch 124.

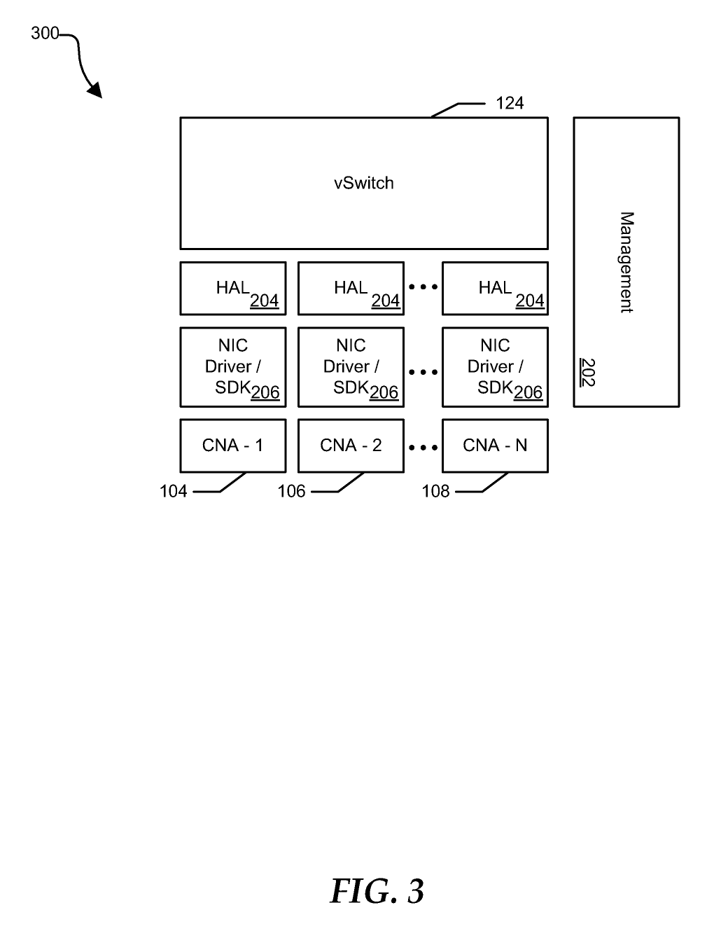

FIG. 3 shows a block diagram of another embodiment of a system architecture 300 of the information handling system 100 including the CNAs 104, 106, and 108, the vSwitch 124, the management block 202, the HAL 204, and the NIC driver/SDK 206 for each CNA. When a CNA, such as the CNA 108, is connected to the vSwitch 124, the vSwitch can send a register request to the CNA via the HAL 204 and the NIC driver/SDK 206. As stated above, the NIC driver/SDK 206 can be an API implemented by the vSwitch 124, which enables the vSwitch and the HAL 204 to interact with the CNAs 104, 106, and 108. Each CNA 104, 106, and 108 can reply to the register request via the NIC driver/SDK 206 during an initialization period of the CNAs. When the CNAs 104, 106, and 108 have registered with the vSwitch 124, the vSwitch can assign a unique identification number to each of the CNAs and can send each CNA its unique identification number. The vSwitch 124 can then send a discover attributes request to the CNAs 104, 106, and 108. Each CNA 104, 106, and 108 can provide the vSwitch 124 with the capabilities and configuration of the CNA via the HAL 204 and the NIC driver/SDK 206. The capabilities of the CNA 108 can include capabilities of a virtual switch, a virtual network interface controller (vNIC), and the like of the CNA.

The vSwitch 124 can set advanced data traffic policies for the CNAs 104, 106, and 108 based on the traffic policies set for the virtual machines 112, 114, 116, 118, and 120 by the management block 202. The vSwitch 124 can then transmit a configure attributes request to the CNAs 104, 106, and 108 to create a vNIC in each of the CNAs that can support a vNIC. For example, if the CNA 104 has the capability of implementing a virtual switch or a vNIC, the vSwitch 124 can transmit the configure attributes request to the CNA. The configure attributes request can cause the CNA 104 to implement the virtual switch or the vNIC based on the traffic policies of the virtual machines 112, 114, 116, 118, and 118. If the CNA 104 does not have the capability of implementing a virtual switch or a vNIC, then the vSwitch 124 can create a software based vNIC in the vSwitch based on the traffic policies of the virtual machines 112, 114, 116, 118, and 118, and based on software capabilities of the vSwitch. If the CNA 108 has the capability of implementing a virtual switch or a vNIC, the vSwitch 124 can transmit the configure attributes request to the CNA. The configure attributes request can cause the CNA 108 to implement the virtual switch or the vNIC based on the traffic policies of the virtual machines 112, 114, 116, 118, and 118. Thus, each CNA can be configured differently based on the capabilities and configurations of the individual CNA.

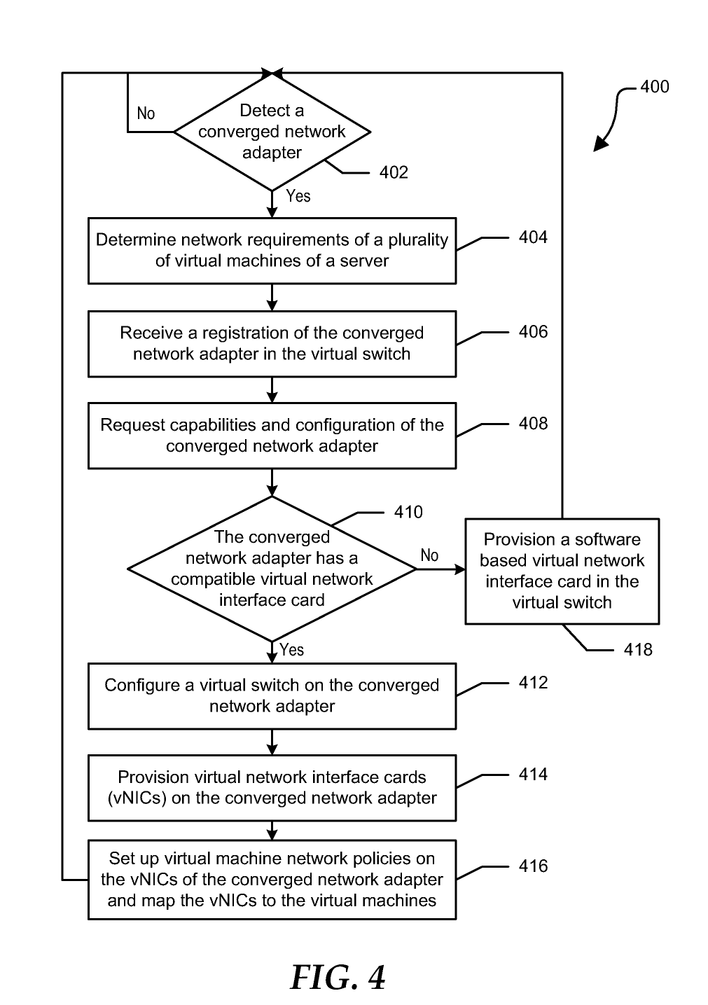

FIG. 4 shows method 400 for configuring a converged network adapter connected to the information handling system 100. At block 402, a determination is made whether a converged network adapter is connected to a server. When a converged network adapter is detected, network requirements of a plurality of virtual machines of the server are determined at block 404. The network requirements can in quality of service requirements, traffic management requirements, security features, and the like. At block 406, a registration of the converged network adapter is received in a vSwitch of the server. The registration can be received via an API of the vSwitch, such as a HAL, a NIC/CNA SDK, or the like. Capabilities and a configuration of the converged network adapter are requested at block 408.

At block 410, a determination is made whether the converged network adapter has a vNIC that is compatible with the network requirements of the plurality of virtual machines. If the converged network adapter has a vNIC that is compatible with the network requirements of the virtual machines, a virtual switch is configured on the converged network adapter at block 412. The virtual switch on the converged network adapter can be configured by creating or deleting vNICs within the converged network adapter, or by setting virtual network interface policies for the vNIC. The virtual network interface policies can be the quality of service requirement for the virtual machines, the traffic management requirement for the virtual machines, or the like. At block 414, vNICs of the converged network adapter are provisioned. At block 416, virtual machine network policies are set up on the vNICs of the converged network adapter and the vNICs are mapped to the virtual machines, and the flow can continue as stated above at block 402 for any additional converged network adapters. If the converged network adapter does not have a vNIC that is compatible with the network requirements of the virtual machines, a software based virtual network interface card is provisioned in the vSwitch at block 418, and the flow can continue as stated above at block 402 for any additional converged network adapters.

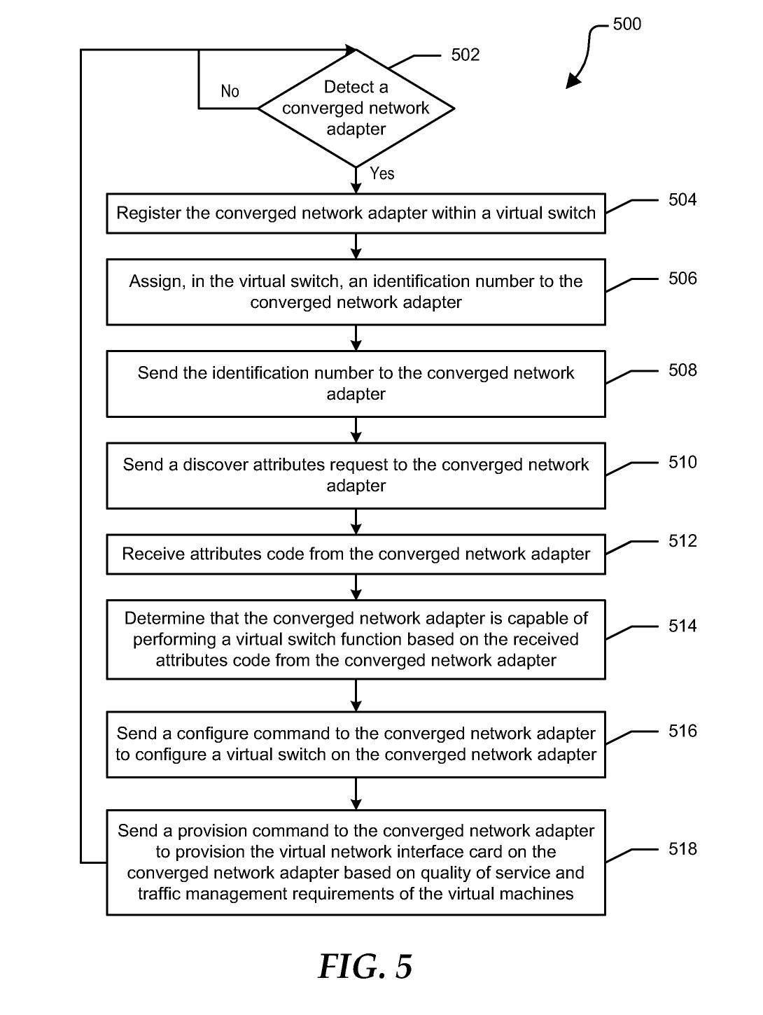

FIG. 5 shows another method 500 for configuring a converged network adapter connected to the information handling system 100. At block 502, a determination is made whether a converged network adapter is connected to a server. When a converged network adapter is detected, the converged network adapter is registered within a vSwitch of the server at block 504. At block 506, an identification number is assigned, in the vSwitch, to the converged network adapter. The identification number is sent to the converged network adapter at block 508. At block 510, a discover attributes request is sent to the converged network adapter. The discover attributes request can be sent to the converged network adapter via an API of the vSwitch, such as a HAL, a NIC/CNA SDK, or the like.

At block 512, an attributes code is received from the converged network adapter. Based on the received attributes code from the converged network adapter, a determination is made that the converged network adapter is capable of performing a virtual switch function at block 514. At block 516, a configure command is sent to the converged network adapter to configure a virtual switch on the converged network adapter. The converged network adapter can configure the virtual switch by creating a vNIC and/or deleting a vNIC on the converged network adapter. A provision command is sent to the converged network adapter to provision the vNIC based on the quality of service requirement and traffic management requirements of the virtual machines at block 518, and the flow can continue as stated above at block 502 for any additional converged network adapters.

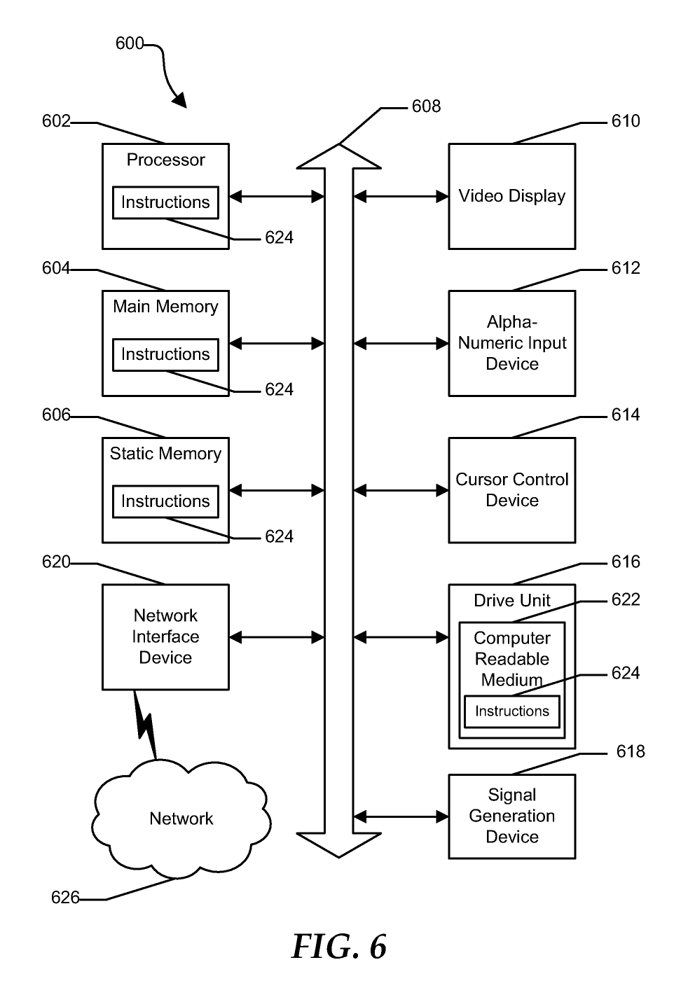

FIG. 6 shows an illustrative embodiment of a general computer system 600 in accordance with at least one embodiment of the present disclosure. The computer system 600 can include a set of instructions that can be executed to cause the computer system to perform any one or more of the methods or computer based functions disclosed herein. The computer system 600 may operate as a standalone device or may be connected such as using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 600 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 600 can be implemented using electronic devices that provide voice, video or data communication. Further, while a single computer system 600 is illustrated, the term “system” shall also be taken to include any collection of systems or sub-systems that individually or jointly execute a set, or multiple sets, of instructions to perform one or more computer functions.

The computer system 600 may include a processor 602 such as a central processing unit (CPU), a graphics processing unit (GPU), or both. Moreover, the computer system 600 can include a main memory 604 and a static memory 606 that can communicate with each other via a bus 608. As shown, the computer system 600 may further include a video display unit 610, such as a liquid crystal display (LCD), an organic light emitting diode (OLED), a flat panel display, a solid state display, or a cathode ray tube (CRT). Additionally, the computer system 600 may include an input device 612, such as a keyboard, and a cursor control device 614, such as a mouse. The computer system 600 can also include a disk drive unit 616, a signal generation device 618, such as a speaker or remote control, and a network interface device 620.

In a particular embodiment, as depicted in FIG. 6, the disk drive unit 616 may include a computer-readable medium 622 in which one or more sets of instructions 624 such as software, can be embedded. Further, the instructions 624 may embody one or more of the methods or logic as described herein. In a particular embodiment, the instructions 624 may reside completely, or at least partially, within the main memory 604, the static memory 606, and/or within the processor 602 during execution by the computer system 600. The main memory 604 and the processor 602 also may include computer-readable media. The network interface device 620 can provide connectivity to a network 626, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 624 or receives and executes instructions 624 responsive to a propagated signal, so that a device connected to a network 626 can communicate voice, video or data over the network 626. Further, the instructions 624 may be transmitted or received over the network 626 via the network interface device 620.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A server comprising:
a plurality of virtual machines partitioned on the server; and
a first virtual switch in communication with the virtual machines, the first virtual switch configured to detect a connection of a first converged network adapter to the server, to determine network requirements of the virtual machines, to determine whether the first converged network adapter has a first virtual network interface card that is compatible with the network requirements of the virtual machines, and if the first virtual network interface card of the first converged network adapter is compatible with the network requirements of the virtual machines, then the first virtual switch provisions the first virtual network interface card as a second virtual switch for the virtual machines, otherwise the first virtual switch provisions a software-based virtual network interface card in the first virtual switch.

2. The server of claim 1 further comprising:
a hypervisor in communication with the first virtual switch, the hypervisor configured to control an operation of the virtual machines.

3. The server of claim 2 further comprising:
a management block in communication with the first virtual switch, the management block configured to set the network requirements of the virtual machines.

4. The server of claim 3 wherein the network requirements of the virtual machines are selected from a group consisting of layer-2 protocol features, layer-3 protocol features, security features, quality of service requirements, and traffic management requirements.

5. The server of claim 1 wherein the first virtual switch is further configured detect a second converged network adapter, to determine whether the second converged network adapter has a second virtual network interface card that is compatible with the network requirements of the virtual machines, and if the second virtual network interface card of the second converged network adapter is compatible with the network requirements of the virtual machines, then the first virtual switch provisions the second virtual network interface card as a third virtual switch for the virtual machines, otherwise the first virtual switch provisions the software-based virtual network interface card in the first virtual switch.

6. The server of claim 5 wherein the first converged network adapter and the second converged network adapter have different capabilities.

7. The server of claim 1 wherein the first virtual switch is further configured to discover the capabilities of the first converged network adapter.

8. The server of claim 1 wherein the first virtual switch utilizes a hardware abstraction layer, the hardware abstraction layer is configured as an application programming interface to interface the first virtual switch with the first converged network adapter.

9. A method comprising:
detecting a connection of a converged network adapter to a server;
determining network requirements of a plurality of virtual machines of the server;
determining whether the converged network adapter has a virtual network interface card that is compatible with the network requirements of the virtual machines; and
if the virtual network interface card of the converged network adapter is compatible with the network requirements of the virtual machines, then provisioning the virtual network interface card as a first virtual switch for the virtual machines, otherwise provisioning a software-based virtual network interface card in a second virtual switch located on the server.

10. The method of claim 9 further comprising:
receiving a registration of the converged network adapter, wherein the registration of the converged network adapter occurs during an initialization period of the converged network adapter; and
request capabilities and a configuration of the converged network adapter.

11. The method of claim 9 further comprising:
configuring the first virtual switch on the converged network adapter;
setting up network policies for the virtual machines on the virtual network interface card of the converged network adapter; and
mapping the virtual network interface card of the converged network adapter to the virtual machines.

12. The method claim 11 wherein the network policies for the virtual machines set up on the converged network adapter are based on a quality of service requirement of the virtual machines.

13. The method claim 11 wherein the network policies for the virtual machines set up on the converged network adapter are based on a traffic management requirement of the virtual machines.

14. A method comprising:
detecting a connection of a converged network adapter to a server;
determining network requirements of a plurality of virtual machines of the server;
receiving attribute codes from the converged network adapter;
determining that the converged network adapter is capable of performing a virtual switch function for the virtual machines based on the received attribute codes;
sending a configure command to the converged network adapter, wherein the configure command causes the converged network adapter to configure a virtual switch on the converged network adapter; and
sending a provision command to the converged network adapter, wherein the provision command causes the converged network adapter to provision a first virtual network interface card based on a quality of service requirement of the virtual machines, and based on a traffic management requirement of the virtual machines.

15. The method of claim 14 further comprising:
receiving a registration of the converged network adapter, wherein the registration of the converged network adapter occurs during an initialization period of the converged network adapter;
assigning an identification number to the converged network adapter;
sending the identification number to the converged network adapter; and
sending a discover attributes request to the converged network adapter.

16. The method of claim 14 wherein configuring the virtual switch of the converged network adapter includes:
creating the first virtual network interface card on the converged network adapter.

17. The method of claim 14 wherein configuring the virtual switch of the converged network adapter includes:
deleting a second virtual network interface card on the converged network adapter.

18. The method of claim 14 wherein the network requirements of the virtual machines includes the quality of server requirement for the virtual machines.

19. The method of claim 14 wherein the network requirements of the virtual machines includes the traffic management requirement for the virtual machines.
